(19) United States
(12) Patent Application Publication
(10) Pub. No.: US 2024/0319314 A1
(43) Pub. Date: Sep. 26, 2024

(54) METHODS, APPARATUSES AND SYSTEMS FOR CLASSIFYING USER EQUIPMENT MEASUREMENTS FOR POSITIONING ESTIMATION

(71) Applicant: ZTE Corporation, Shenzhen (CN)

(72) Inventors: Junpeng LOU, Shenzhen (CN); Chuangxin JIANG, Shenzhen (CN); Di ZONG, Shenzhen (CN); Focai PENG, Shenzhen (CN); Yu PAN, Shenzhen (CN); Mengzhen LI, Shenzhen (CN)

(21) Appl. No.: 18/735,881

(22) Filed: Jun. 6, 2024

Related U.S. Application Data
(63) Continuation of application No. PCT/CN2022/129585, filed on Nov. 3, 2022.

(51) Int. Cl. G01S 5/02; G01S 19/39

(52) U.S. Cl. CPC G01S 5/0244; G01S 19/396

(57) ABSTRACT

Methods, apparatus and systems for classifying user equipment measurements for positioning estimation are described. In one embodiment, a method performed by a first wireless communication node, includes: transmitting a measurement initiation request configured to be received by a wireless communication device; receiving a measurement initiation response, wherein the measurement initiation response comprises a plurality of measurements performed by the wireless communication device for estimating a position of the wireless communication device, wherein the plurality of measurements is classified into a plurality of groups; and performing a positioning integrity analysis by estimating an error distribution for at least one of the plurality of groups.

### CROSS-REFERENCE TO RELATED APPLICATION(S)

This application is a continuation of PCT Application No. PCT/CN2022/129585, filed on Nov. 3, 2022, the disclosure of which is incorporated herein by reference in its entirety.

### TECHNICAL FIELD

The disclosure relates generally to wireless communications and, more particularly, to methods, apparatuses and systems for classifying user equipment measurements for positioning estimation.

### BACKGROUND

Global navigation satellite systems (GNSS) are widely used for safety-of-life positioning applications. Such applications require high integrity, availability, and continuity of the positioning service. It is important to ensure that mobile devices can properly assess the positioning uncertainty and relate it to safety margins to ensure trust by enabling devices to indicate when reliable positioning is available or not available. This process is known as positioning integrity. Positioning integrity can be assessed by a protection level (PL), which is an estimation of the maximum positioning error at extremely low probability levels. The PL is related to the ability of a system to provide timely warnings to users when the system should not be used by safety-critical applications. Examples of factors that can impact positioning integrity and cause degradation of GNSS positioning performances include limited satellite visibility, multipath effect, interference and foliage attenuation.

Examples of error sources that can affect GNSS positioning integrity include ephemeris errors, satellite clock errors, multipath distortion errors, tropospheric effects, and/or other types of error sources. When GNSS positioning integrity is deemed to be sufficient (reliable and trustworthy, no residual error), the application using the positioning information can operate according to its standard operating procedures and in accordance with application safety requirements. When the positioning integrity is deemed to be insufficient (for example a large residual error occurs), the application should take pre-defined precautionary actions to prevent negative outcomes. Conventional techniques for estimating residual errors (i.e., difference between the estimate value and actual value) in positioning integrity analysis use a zero-mean normal distribution with an overbounding standard deviation, and the accuracy of positioning integrity analysis provided by such techniques is not entirely satisfactory.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method performed by a first wireless communication node, includes: transmitting a measurement initiation request to a second wireless communication node, receiving a measurement initiation response from the second wireless communication node, wherein the measurement initiation response comprises a plurality of measurements taken at a wireless communication device for positioning estimation of the wireless communication device, classifying the plurality of measurements into a plurality of groups, and performing positioning integrity analysis by estimating an error distribution for at least one of the plurality of groups.

In further embodiments, a method performed by a first wireless communication node, includes: transmitting a measurement initiation request to a second wireless communication node, receiving a measurement initiation response from the second wireless communication node, wherein the measurement initiation response comprises a plurality of sets of measurements taken at a wireless communication device used for positioning estimation of the wireless communication device, classifying the plurality of sets of measurements into a plurality of groups based on a first type of measurement in a plurality of types of measurements, classifying at least one of the plurality of groups into a respective set of a plurality of subgroups based on a second type of measurement in the plurality of types of measurements; and performing positioning integrity analysis by estimating an error distribution for at least one of the plurality of types of measurements in at least one subgroup of the plurality of subgroups.

In some embodiments, a wireless communication node includes: a transceiver configured to transmit a measurement initiation request to a second wireless communication node, receive a measurement initiation response from the second wireless communication node, wherein the measurement initiation response comprises a plurality of measurements taken at a wireless communication device for positioning estimation of the wireless communication device, and at least one processor configured to classify the plurality of measurements into a plurality of groups, and perform positioning integrity analysis by estimating an error distribution for at least one of the plurality of groups.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary wireless communication network, in accordance with some embodiments of the present disclosure.

FIG. 2 illustrates another exemplary wireless communication network, in accordance with some embodiments of the present disclosure.

FIG. 3A illustrates a signaling diagram between a Base Station (BS), a User Equipment (UE), and a Location Management Function (LMF), in accordance with some embodiments.

FIG. 3B illustrates a signaling diagram between a UE and an LMF, in accordance with some embodiments.

FIG. 4 illustrates an exemplary levelization of UE measurements for positioning estimation, in accordance with some embodiments.

FIG. 5 illustrates an example method performed by a network node for classifying a plurality of measurements taken at a UE into a plurality of groups, in accordance with some embodiments.

FIG. 6 illustrates another example method performed by a network node for classifying a plurality of sets of measurements taken at a UE for positioning integrity analysis, in accordance with some embodiments.

FIG. 7 illustrates a block diagram of a network node, in accordance with various embodiments of the disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

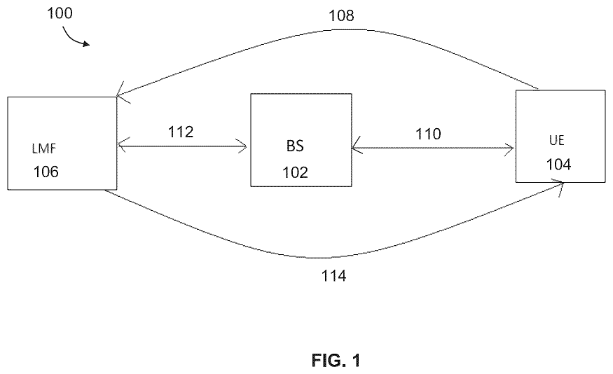

FIG. 1 illustrates an exemplary wireless communication network 100, in accordance with some embodiments of the present disclosure. In the wireless communication system 100, a network-side wireless communication node can be a node B, an E-UTRAN Node B (also known as Evolved Node B, eNodeB or eNB), a gNodeB (also known as gNB) in new radio (NR) technology, a pico station, a femto station, or the like. In some embodiments, a network-side wireless communication node can also comprise a Relay Node (RN), a multicell coordination entity (MCE), a gateway (GW), a sidelink management/control node, a mobility management entity (MME), a EUTRAN Operation/Administration/Maintenance (OAM) device. A terminal-side wireless communication device can be a long range communication system like a mobile phone, a smart phone, a personal digital assistant (PDA), tablet, laptop computer, or a short range communication system such as, for example a wearable device, a vehicle with a vehicular communication system and the like.

A network-side wireless communication node is represented by a base station (BS) 102 hereinafter in all embodiments, and is generally referred to as “wireless communication node”. Further, a wireless communication device, hereinafter, also refers to a specific user equipment (UE), which includes one of the following: a roadside unit (RSU), a leading UE in a vehicular communication group (platoon). A terminal-side communication device is represented by a user equipment (UE) 104 hereinafter in all embodiments, and is generally referred to as “wireless communication devices”. Such communication nodes and devices may be capable of wireless and/or wired communications, in accordance with various embodiments of the invention. It is noted that all the embodiments are merely preferred examples, and are not intended to limit the present disclosure. Accordingly, it is understood that the system may include any desired combination of UEs and BSs, while remaining within the scope of the present disclosure.

Referring to FIG. 1, the wireless communication network 100 includes a BS 102, a UE 104, and a Location Management Function (LMF) 106. Although only a single BS 102, a single UE 104, and a single LMF 106 are shown in FIG. 1, it is understood that additional BSs, UEs and LMFs can be present in the wireless communication network 100 to implement the method and techniques described herein, in accordance with various embodiments of the disclosure. The LMF 106 may be referred to as a network entity in a core network configured to support location determination of the UE 104, obtain downlink location measurements or a location estimate from the UE 104, obtain uplink location measurements from the BS 102, and obtain non-UE associated assistance data from the BS 102 and/or the UE 104. The LMF 106 may interact with the BS 102 and the UE 104 in order to obtain position measurements from the UE 104 for positioning calculation of the UE 104. In some embodiments, the LMF 106 may interact with multiple BSs 102 to provide assistance data information for broadcasting. The assistance data information for broadcast may be segmented and/or ciphered by the LMF 106. In some embodiments, the UE 104 has direct communication channels 110 with the BS 102, the UE 104 has direct communication channels 108 and 114 with the LMF 106, and the BS 102 has direct communication channels 112 with the LMF 106. In some embodiments, the BS 102 may be configured to transmit a downlink positioning reference signal (PRS) to the UE 104 through the communication channels 110, and the UE 104 may be configured to estimate a positioning error based on the PRS signal. In some embodiments, the UE 104 may be configured to transmit a sounding reference signal (SRS) to the BS 102 through the communication channels 110 to estimate the uplink channel quality over a wider bandwidth.

In some embodiments, the LMF 106 transmits a first measurement request message to the UE 104 through the communication channel 114 for positioning calculation. The first measurement request message may include information such as Reference Time, Reference Location, Ionospheric Models, Earth Orientation Parameters, GNSS-GNSS Time Offsets, Differential GNSS Corrections, Ephemeris and Clock Models, Real-Time Integrity, Data Bit Assistance, Acquisition Assistance, Real Time Kinematics (RTK) Reference Station Information, RTK Auxiliary Station Data, RTK Observations, RTK Common Observation Information, RTK Residuals, Space-State Representation (SSR) Orbit Corrections, SSR Clock Corrections, SSR Code Bias, SSR Phase Bias, SSR Gridded Correction, SSR Usear Range Accuracy (URA), SSR Correction Points, Integrity Service Parameters, Integrity Alerts.

In some embodiments, the UE 104 transmits a first measurement result report message back to the LMF 106 through the communication channel 108 based on the first measurement request message. The first measurement result report message may include information such as latitude/longitude/altitude with uncertainty shape, velocity with uncertainty shape, reference time with GNSS to NG-RAN time association and uncertainty, indication of used positioning methods in the fix, code phase measurements, doppler measurements, carrier phase measurements, carrier-to-noise ratio of the received signal, measurement quality parameters for each measurement, and/or non-GNSS related measurement information.

In some embodiments, the LMF 106 may determine position methods to be used for positioning estimation of the UE 104 based on factors that may include the Location Services (LCS) Client type, the required Quality of Service (QOS), UE positioning capabilities, gNB positioning capabilities and ng-eNB positioning capabilities. The positioning methods may yield a location estimate for UE-based position methods and/or positioning measurements for UE-assisted and network-based position methods. The LMF may combine all the received results and determine a single location estimate for a target UE (hybrid positioning). Additional information like accuracy of the location estimate and velocity may also be determined.

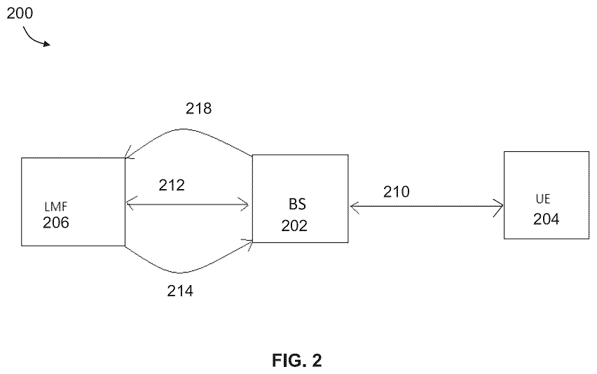

FIG. 2 illustrates another exemplary wireless communication network 200, in accordance with some embodiments of the present disclosure. In some embodiments, an LMF 206 transmits a measurement request message to a BS 202 through communication channels 212 and 214 for positioning estimation of a UE 204, and the BS 202 transmits a measurement result report message back to the LMF 206 through communication channels 212 and 218 based on the measurement request message. The BS 202 may be then configured to transmit the measurement request message to the UE 204 and receive measurements taken at the UE 204 through a communication channel 210.

In some embodiments, the LMF 206 may be configured to calculate a protection level (PL) based on the measurement result report message. A PL may be referred to as a statistical upper-bound of the Positioning Error (PE) that ensures that, the probability per unit of time of the true error being greater than an Alert Limit (AL) and the PL being less than or equal to the AL, for longer than the Time to Alert (TTA), is less than a required Target Integrity Risk (TIR), wherein the AL for a given parameter measurement may be referred to as an error tolerance not to be exceeded without issuing an alert. The TTA may be referred to as a maximum allowable time elapsed from the onset of the navigation system being out of tolerance until the equipment enunciates the alert, and the TIR may be referred to as a required probability limit for integrity risk. In some embodiments, the PL is calculated by the LMF 206 to satisfy the following inequality:

$$Probability per unit of time [ ( ( PE > AL ) \& ( P L < = AL ) ) for longer than TTA ] < required TIR \qquad ( Equation 1 )$$

In some embodiments, for positioning integrity operations, the wireless communication network 200 ensures that

$$P ( Error > Bound for longer than TTA \vert NOT DNU ) <= Residual Risk + IRallocation \qquad ( Equation 2 )$$

where P denotes probability, Error can be defined as the difference between the true value of a GNSS parameter (e.g. ionosphere, troposphere etc.) and its value as estimated and provided in the corresponding assistance data. Integrity Risk allocation (IRallocation) may be a component that corresponds to the contribution from the Bound according to a Bound formula. DNU may be a status corresponding to Do Not Use (DNU) flag for a specific measurement. In some embodiments, a factor value can be used to represent whether a specific integrity parameter is reliable or not, such that factor=0 denotes the integrity parameter is unreliable, and factor=1 denotes the integrity parameter is reliable. In such embodiments, P(Error>Bound for longer than TTA|NOT DNU) in (Equation 2) can be replaced by P(Error>Bound for longer than TTA|factor(s)>0). In some embodiments, the Error follows a normal distribution characterized by a mean and a standard deviation. In some other embodiments, the Error follows a non-normal distribution such as a uniform distribution, a log-normal distribution, a multimodal distribution, a binomial distribution, a Poisson distribution, and a non-parametric distribution.

In some embodiments, if the Error values follows a non-normal distribution, distribution transformation techniques such as Box-Cox transformation may be employed to convert the non-normal Error distribution to a normal Error distribution such that the positioning integrity analysis can be performed in a more efficient way. In some embodiments, parameters describing the Error distribution can be expressed in ranges. For example, an Error distribution may be a normal distribution with mean in the range of [a, b] and standard deviation in the range of [c, d]. In one example, the Error is a Time of Arrival (ToA) error, and the range parameters may be set to a=0, b=5 ns, c=1 ns, d=5 ns. In another example, the Error is an Angle of Arrival (AoA) error, and the range parameters may be set to a=0 degree, b=30 degree, c=0.1 degree, d=30 degree. In yet another example, Error is expressed by a confidence level defined as the probability that the Error value falls within a specified range. In some embodiments, the PL can be calculated by a Bound formula associated with the Error distribution:

$$\begin{matrix}Bound = mean + K * stdDev \\ K = normInv ( IRallocation / 2 ) \\ irMinimum <= IRallocation <= irMaximum\end{matrix} \qquad ( Equation 3 )$$

where mean and stdDev are the mean and the standard deviation for the Error distribution, and irMinimum and irMaximum are the minimum and maximum limit for IRallocation. In some embodiments, the irMinimum and irMaximum values are chosen by users of the wireless communication network 200. In other embodiments, an alarm is issued if a calculated error is out of the Bound defined in (Equation 3).

In some embodiments, the integrity risk probability P in Equation 1 is decomposed into a constant Residual Risk component provided in the assistance data as well as a variable IRallocation component. IRallocation may be chosen freely by the client based on the desired Bound, therefore the network should ensure that Equation 1 holds for all possible choices of IRallocation. The Residual Risk and IRallocation components may be mapped to fault and fault-free cases respectively. In some embodiments, if the condition specified in Equation 1 cannot be met, then the corresponding DNU flag may be set.

In some embodiments, the integrity Bound as defined in Equation 3 may provide statistical distribution of the residual errors associated with the GNSS positioning corrections. Integrity bounds may be used to statistically bound the residual errors after the positioning corrections have been applied. In one example, the bound formula of Equation 3 describes a bounding model including a mean and standard deviation (e.g. paired over-bounding Gaussian). In another example, the bound may be scaled by multiplying the standard deviation by a scale factor K corresponding to an IRallocation, for any desired IRallocation within the permitted range. In some embodiments, the Residual Risk is defined per unit of time and represents the probability that the feared event begins. Each Residual Risk may be accompanied by a mean duration which represents the expected mean duration of the corresponding feared event and is used to convert the Probability of Onset to a probability that the feared event is present at any given time. As will be described in further detail below, in accordance with some embodiments, error distribution for a specific measurement is estimated not only once as shown, for example, in Equation 2, but a plurality of times corresponding to a plurality of groups for one or more measurements, such that the positioning integrity analysis can be performed in a more efficient way. In accordance with further embodiments, position integrity analysis can be performed by estimating an error distribution for at least one of the plurality of groups, wherein each of the plurality of groups are determined based on certain criteria, as discussed in further detail below.

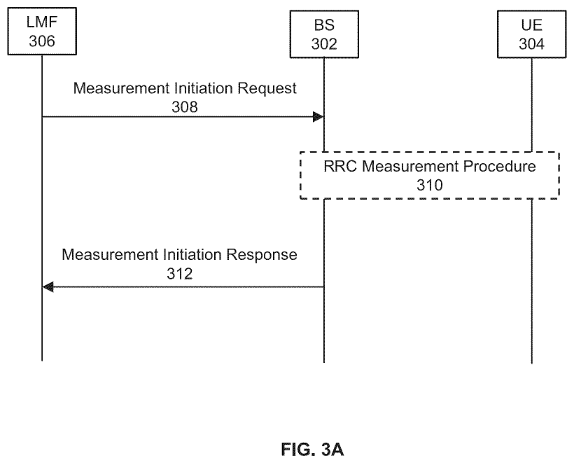

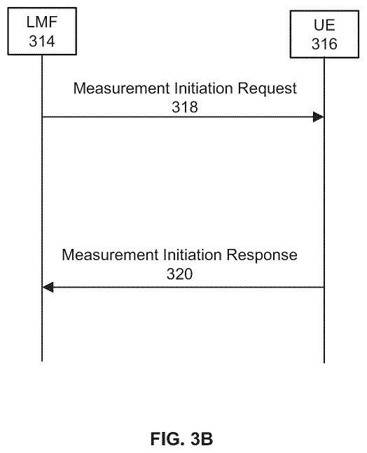

FIG. 3A illustrates a signaling diagram between a BS 302, a UE 304 and an LMF 306 for performing a method for UE positioning, in accordance with some embodiments. In some embodiments, the method for UE positioning is performed under a UE-based mode. The UE-based mode may be referred to a positioning estimate mode wherein a UE is responsible for providing measurements to an LMF and making the positioning calculation. In the UE-based mode, the UE 304 may be configured to report one or more of a latitude, a longitude, an altitude, a velocity with an estimate of the uncertainty, and an estimate of the location uncertainty to the LMF 306 through an RRC measurement procedure 310 and a measurement initiation response 312, in accordance with some embodiments. In some embodiments, the UE 304 is configured to measure the difference in the arrival times of downlink radio signals from a plurality of BSs 302, wherein each of the plurality of BSs 302 transmits reference signals to the UE 304. Then the UE 304 may compare arrival times of the reference signals and use the difference in the arrival times combined with location information of the plurality of BSs 302 to determine the position of the UE 304.

In other embodiments, the method for UE positioning is performed under a UE-assisted mode. In UE-assisted mode, a UE may be placed in a positioning estimate mode wherein the UE is responsible for providing measurements to an LMF for positioning calculation but the UE does not make the positioning calculation itself. In the UE-assisted mode, the UE 304 may be configured to report timing related (e.g., a timing difference), angle related (e.g., AOA, ZOA), beam related (e.g., boresight direction) measurements, RSRP/RSRPP, Code Phase and Doppler measurements, any one or more of these measurements with associated quality measurements (e.g., TimingQuality), and/or any additional parameters needed for positioning calculation to the LMF 306.

In some embodiments, the LMF 306 may be configured to transmit a measurement initiation request 308 to the BS 302. In accordance with various embodiments, the measurement initiation request 308 may be an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request 308 includes an indication of measurements requested to be performed by the UE 304 and whether such measurement results from the UE 304 are expected only once or periodically. In some embodiments, upon receiving the measurement initiation request 308, the BS 302 may transmit the measurement initiation request 308 to the UE 304 through an RRC measurement procedure 310, and receive one or more measurement results from the UE 304 through the RRC measurement procedure 310.

In some embodiments, the measurement initiation request 308 indicates that the result from the UE 304 is expected only once, and the BS 302 initiates at least one measurement at the UE 304 as requested. Upon receiving the at least one measurement from the UE 304, the BS 302 may be configured to send a measurement initiation response 312 to the LMF 306, wherein the measurement initiation response 312 comprises the at least one measurement taken by the UE 304. In some other embodiments, the measurement initiation request 308 indicates that measurement result from the UE 304 is expected periodically, and the BS 302 initiates a periodic measurement procedure at the UE 304 as requested through the RRC measurement procedure 310. Upon receiving periodic measurements from the UE 304, the BS 302 may be configured to send the measurement initiation response 312 to the LMF 306, wherein the measurement initiation response 312 comprises the periodic measurements taken by the UE 304.

In some embodiments, the BS 302 is unable to instigate any of the required RRC procedures to obtain the requested measurements from the UE 304, then the BS 302 may be configured to send the measurement initiation response 312 comprising a failure message with indicated error reason to the LMF 306. In some embodiments, a failure occurs during a periodic reporting from the UE 304, and the BS 302 may be configured to report the measurement initiation response 312 comprising a periodic failure message with indicated error reason to the LMF 306.

FIG. 3B illustrates a signaling diagram between a UE 316 and an LMF 314 for performing UE positioning estimation, in accordance with some embodiments. In some embodiments, the LMF 314 is configured to transmit a measurement initiation request 318 directly to the UE 316. Upon receiving the measurement initiation request 318, the UE 316 may perform measurements accordingly and transmit a measurement initiation response 320 back to the LMF 314. The functions of the LMF 314, the UE 316, the measurement initiation request 318, and the measurement initiation response 320 are described above with reference to FIG. 3A and are, therefore, not repeated here.

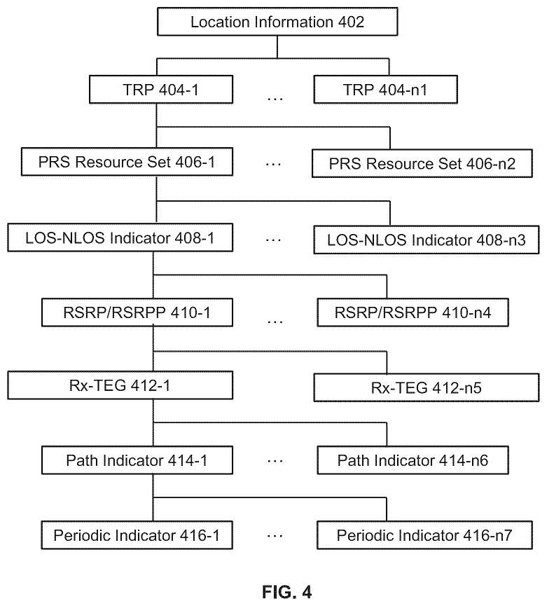

In some embodiments, upon receiving the measurement initiation request 318, the UE 316 may be configured to obtain UE measurements accordingly for positioning estimation. FIG. 4 illustrates exemplary levels of UE measurements for positioning estimation, in accordance with some embodiments. In some embodiments, the UE 316 may be configured to obtain location information 402 comprising a plurality of measurements at different levels for positioning estimation. In some embodiments, the location information 402 comprises location measurements from a plurality of Transmission and Reception Points (TRPs) 401-1 to 401-n1 that transmit reference signals to the UE 316. Each of the plurality of the TRPs 401-1 to 401-n1 may be associated with a plurality of Positioning Reference Signal (PRS) resource sets. In one example, the TRP 404-1 is associated with a plurality of PRS resource sets 406-1 to 406-n2.

In some embodiments, each of the plurality of the PRS resource sets 406-1 to 406-n2 is associated with a plurality of Line of Sight or Non Line of Sight (LOS-NLOS) indicators. In one example, the PRS resource set 406-1 is associated with a plurality of LOS-NLOS indicators 408-1 to 408-n3.

In some embodiments, each of the plurality of the LOS-NLOS indicators 408-1 to 408-n3 is associated with a plurality of Reference Signal Received Powers (RSRPs)/Reference Signal Received Path Powers (RSRPPs). In one example, the LOS-NLOS indicator 408-1 is associated with a plurality of RSRPs/RSRPPs 410-1 to 410-n4. In some embodiments, each of the plurality of the RSRPs/RSRPPs 410-1 to 410-n4 is associated with a plurality of Rx-Timing Error Groups (TEGs). In another example, the RSRP/RSRPP 410-1 is associated with a plurality of Rx-TEGs 412-1 to 412-n5. In some embodiments, each of the plurality of the Rx-TEGs 412-1 to 412-n5 is associated with a plurality of Path Indicators used to indicate whether a UE measurement is taken on a first path or not. In yet another example, the Rx-TEG 412-1 is associated with a plurality of Path Indicators 414-1 to 414-n6. In some embodiments, each of the plurality of the Path Indicators 414-1 to 414-n6 is associated with a plurality of Periodic Indicators used to indicate whether the UE 316 reports measurements to the LMF 314 periodically or aperiodically. In still another example, the Path Indicator 414-1 is associated with a plurality of Periodic Indicators 416-1 to 416-n7.

Although several types of UE measurements are shown in FIG. 4, it is understood that additional UE measurements such as ToA, Relative Time of Arrival (RTOA) measurements, AoA measurements, Angle of Departure (AoD) measurements, UE Rx-Tx timing difference measurements, BS Rx-Tx timing difference measurements, inter-TRP synchronization measurements, and/or any other types of UE measurements can be used to implement the method and techniques described herein, in accordance with various embodiments of the disclosure. In one example, the UE measurement errors follow a normal distribution with a zero mean and a standard deviation and only the standard deviation is used for positioning integrity analysis. In another example, the UE measurement errors follow a normal distribution with a non-zero mean and a standard deviation and both the mean and the standard deviation are used for positioning integrity analysis. In yet another example, the UE measurement errors follow an asymmetric distribution such as a multimodal distribution with a plurality of modes, and the plurality of modes are used for positioning integrity analysis.

In one example, the UE 316 transmits a set of measurements for positioning estimation to the LMF 306. In some embodiments, the set of measurements comprises Reference Signal Time Difference (RSTD) measurements corresponding to a set of TRP signals received by the UE 316 from a set of TRPs. For example, the set of measurements may comprise m RSTD measurements obtained from m TRP signals transmitted by m TRPs to the UE for UE positioning estimation. Upon receiving the m RSTD measurements, the LMF 314 may be configured to classify the m RSTD measurements into n groups, m≥n, wherein each group of RSTD measurements corresponds to a group of TRPs with similar geographical locations. In some embodiments, a predetermined TRP threshold value Tth may be used to classify the m RSTD measurements into n groups. Algorithm 1 below illustrates a pseudocode example of a procedure for classifying m RSTD measurements into n groups based on TRP geographical locations. Since TRPs in the same group share similar geographical locations, one single error distribution for one group of RSTD measurements can be estimated for positioning integrity analysis. That is, n groups of RSTD measurements can result in n different error distributions. In some embodiments, the m RSTD measurements comprise a set of 5 values: [0 Ts, 1 Ts, 2 Ts, 2000 Ts, 2001 Ts], where Ts is defined as the basic time unit of RSTD measurements with Ts=1/(15000×2048) seconds. Instead of estimating one single error distribution for all the 5 RSTD measurements, the set of 5 RSTD measurements may be classified into 2 groups: [0 Ts, 1 Ts, 2 Ts] and [2000 Ts, 2001 Ts]. Then one error distribution can be estimated for each of the 2 groups [0 Ts, 1 Ts, 2 Ts] and [2000 Ts, 2001 Ts], resulting in 2 different error distributions for the set of 5 RSTD measurements. In this way, positioning integrity analysis can be performed in a more accurate manner.

Algorithm 1 Pseudocode example of a procedure for classifying m RSTD
measurements into n groups based on TRP geographical locations

```
INPUT m RSTD measurements corresponding to m TRP locations, a predetermined threshold Tth
1. Choose the number of groups n, n ≤m
2. Place the centroids c_1, c_2, ..., c_n randomly for n groups
3. for each RSTD measurement value x_i
  3.1 find the nearest centroid from c_r from {c_1, c_2, ..., c_n}
  3.2 assign the x_i to c_r
4. for each group j=1...n
  4.1 new centroid = mean of all RSTD measurements assigned to that group
5. Repeat steps 3-4 until convergence or until a fixed number of iterations
6. If the largest difference between two RSTD measurements in one group is larger than Tth, assign n=n+1
and repeat steps 2-5
```

In another example, the set of measurements transmitted from the UE 316 to the LMF 314 for positioning estimation comprises a set of m PRS resource measurements. In some embodiments, the set of m PRS resource measurements comprises a set of measured time difference of arrival (TDOA) at the UE 316 for positioning estimation. In some examples, different PRS resource measurements may correspond to different receiving and transmitting beams at the UE 316. In some embodiments, upon receiving the m PRS resource measurements, the LMF 314 may be configured to classify the m PRS resource measurements into n groups, m≥n, wherein each group of PRS resource measurements corresponds to a group of Quality. In some embodiments, a predetermined PRS resource threshold value may be used to classify the m PRS resource measurements into n groups using a procedure similar to Algorithm 1. Since PRS resource measurements in the same group share similar measurement quality, one single error distribution for one group of PRS resource measurements can be estimated for positioning integrity analysis. That is, n groups PRS resource measurements can result in n different error distributions. As discussed above, in this way, positioning integrity analysis can be performed in a more accurate manner.

In yet another example, the set of measurements transmitted from the UE 316 to the LMF 314 for positioning estimation comprises a set of m LOS-NLOS indicators. In some embodiments, upon receiving the m LOS-NLOS indicators, the LMF 314 may be configured to classify the m LOS-NLOS indicators into 2 groups, wherein one group corresponds to a zero value for the LOS-NLOS indicator for LOS, and the other group corresponds to a one value for the LOS-NLOS indicator for NLOS. Since measurements in the same group share the same LOS-NLOS indicator value, one single error distribution for one group of LOS-NLOS indicators can be estimated for positioning integrity analysis. That is, 2 groups LOS-NLOS indicators can result in 2 different error distributions. As discussed above, in this way, positioning integrity analysis can be performed in a more accurate manner.

In still another example, the set of measurements transmitted from the UE 316 to the LMF 314 for positioning estimation comprises a set of m RSRP/RSRPP measurements. In some embodiments, upon receiving the m RSRP/RSRPP measurements, the LMF 314 may be configured to classify the m RSRP/RSRPP measurements into n groups, m≥n, wherein each group of RSRP/RSRPP measurements corresponds to a group of similar signal power quality. In some embodiments, TRPs closer to the UE 316 result in larger RSRP/RSRPP measurement values which may be classified into one group, whereas TRPs further away from the UE 316 result in smaller RSRP/RSRPP measurement values which may be classified into another group. In some embodiments, a predetermined RSRP/RSRPP threshold value may be used to classify the m RSRP/RSRPP measurements into n groups using a procedure similar to Algorithm 1. Since RSRP/RSRPP measurements in the same group share similar signal power quality, one single error distribution for one group of RSRP/RSRPP measurements can be estimated for positioning integrity analysis. That is, n groups RSRP/RSRPP measurements can result in n different error distributions. As discussed above, in this way, positioning integrity analysis can be performed in a more accurate manner.

In still another example, the set of measurements transmitted from the UE 316 to the LMF 314 for positioning estimation comprises a set of m Rx TEG measurements. In some embodiments, each of the set of m Rx TEG measurements is associated with transmissions of one or more uplink sounding reference signals or downlink positioning reference signals. In some embodiments, upon receiving the m Rx TEG measurements, the LMF 314 may be configured to classify the m Rx TEG measurements into n groups, m≥n, wherein each group of Rx TEG measurements corresponds to a group of similar timing delays. In some embodiments, a predetermined Rx TEG threshold value may be used to classify the m Rx TEG measurements into n groups using a procedure similar to Algorithm 1. Since Rx TEG measurements in the same group share similar timing delays, one single error distribution for one group of Rx TEG measurements can be estimated for positioning integrity analysis. That is, n groups Rx TEG measurements can result in n different error distributions. As discussed above, in this way, positioning integrity analysis can be performed in a more accurate manner.

In yet another example, the set of measurements transmitted from the UE 316 to the LMF 314 for positioning estimation comprises a set of m path indicators to indicate whether a UE measurement is taken on a first path. In some embodiments, UE measurements taken on a first path are LOS measurements and UE measurements taken on non-first paths are NLOS measurements. In some embodiments, upon receiving the m path indicators, the LMF 306 may be configured to classify the m path indicators into 2 groups, wherein one group corresponds to a zero value in the path indicator to indicate the first path, and the other group corresponds to a one value in the path indicator to indicate the non-first paths. Since measurements in the same group share the same path indicator value, one single error distribution for one group of path indicators can be estimated for positioning integrity analysis. That is, 2 groups of path indicators can result in 2 different error distributions. As discussed above, in this way, positioning integrity analysis can be performed in a more accurate manner.

In yet another example, the set of measurements transmitted from the UE 316 to the LMF 314 for positioning estimation comprises a set of m periodic indicators to indicate whether the UE 316 transmits measurements to the LMF 314 periodically or aperiodically. In some embodiments, upon receiving the m periodic indicators, the LMF 314 may be configured to classify the m periodic indicators into 2 groups, wherein one group corresponds to a zero value in the periodic indicator to indicate periodic measurement transmission, and the other group corresponds to a one value in the periodic indicator to indicate aperiodic measurement transmission. Since measurements in the same group share the same periodic indicator value, one single error distribution for one group of periodic indicators can be estimated for positioning integrity analysis. That is, 2 groups periodic indicators can result in 2 different error distributions. As discussed above, in this way, positioning integrity analysis can be performed in a more accurate manner.

In still another example, an AOD positioning method utilizes RSRP/RSRPP measurements as the error source. In some embodiments, the AOD positioning method introduces at least one signaling which indicates the distribution of the error (mean and/or std). In further embodiments, from an AOD assistant data aspect, a boresight direction of DL-PRS related error and/or beam information of DL-PRS related error can be an error source. In this case, a mean and/or std (the unit is degrees) can be introduced to represent the distribution of boresight direction.

In still another example, the set of measurements transmitted from the UE 316 to the LMF 314 for positioning estimation comprises a set of m boresight direction measurements. The boresight direction may be referred to as a direction of peak gain of an antenna in the UE 316, and boresight direction measurements can be regarded as the comprehensive results of RSRP/RSRPP measurements error and boresight direction assistance error. In some embodiments, upon receiving the m boresight direction measurements, the LMF 306 may be configured to classify the m boresight direction measurements into n groups, m≥n, wherein each group of boresight direction measurements corresponds to a group of similar directions of antenna peak gain expressed in degree. In some embodiments, a predetermined boresight direction threshold value may be used to classify the m boresight direction measurements into n groups using a procedure similar to Algorithm 1. Since boresight direction measurements in the same group share similar antenna peak gain directions, one single error distribution for one group of boresight direction measurements can be estimated for positioning integrity analysis. That is, n groups boresight direction measurements can result in n different error distributions. As discussed above, in this way, positioning integrity analysis can be performed in a more accurate manner.

In still another example, the set of measurements transmitted from the UE 316 to the LMF 314 for positioning estimation comprises a set of m Rx beam index measurements. In some embodiments, the m Rx beam index measurements are used to evaluate the quality of the received signals at the UE 316. In some embodiments, upon receiving the m Rx beam index measurements, the LMF 314 may be configured to classify the m Rx beam index measurements into n groups, m≥n, wherein each group of Rx beam index measurements corresponds to a group of similar qualities in the received signals at the UE 316. In some embodiments, a predetermined Rx beam index threshold value may be used to classify the m Rx beam index measurements into n groups using a procedure similar to Algorithm 1. Since Rx beam index measurements in the same group share similar signal qualities, one single error distribution for one group of Rx beam index measurements can be estimated for positioning integrity analysis. That is, n groups of Rx beam index measurements can result in n different error distributions. As discussed above, in this way, positioning integrity analysis can be performed in a more accurate manner.

In some embodiments, the UE 316 is configured to take a plurality of sets of measurements and transmit the plurality of sets of measurements to the LMF 314 for positioning estimation, wherein each of the plurality of sets of measurements comprises a plurality of types of measurements, wherein the plurality of types of measurements comprises at least two of: an RSTD measurement, a PRS resource measurement, a LOS-NLOS indicator, an RSRP/RSRPP measurement, an Rx TEG measurement, a path indicator, a periodic indicator, an Rx beam index measurement, and any other types of measurements. Upon receiving the plurality of sets of measurements, the LMF 314 may be configured to classify the plurality of sets of measurements into m1 groups based on the first type of measurements in the plurality of types of measurements using a procedure similar to Algorithm 1. In some embodiments, one single error distribution for each type of measurements in each of the m1 groups can be estimated for positioning integrity analysis. In some other embodiments, the LMF 314 may be configured to classify the sets of measurements in each of the m1 groups into a distinct set of subgroups based on the second type of measurements in the plurality of types of measurements. In one example, the LMF 314 is configured to classify the first group of the m1 groups into m2 subgroups based on the second type of measurements in the plurality of types of measurements. Next the LMF 314 may be configured to classify the sets of measurements in the first subgroup of the m2 subgroups into m3 subgroups based on the third type of measurements in the plurality of types of measurements. This procedure may be repeated until the last type of measurements in the plurality of types of measurements has been used to classify the plurality of sets of measurements taken at the UE 316.

In one example, the UE 316 is configured to take eight sets of measurements for positioning estimation and transmit the eight sets of measurements to the LMF 314, wherein each of the eight sets of measurements comprises two types of measurements: {RSTD measurement, PRS resource measurement}. Thus, the eight sets of measurements may be denoted as: {RSTD measurement_1, PRS resource measurement_1}, {RSTD measurement_2, PRS resource measurement_2}, {RSTD measurement_3, PRS resource measurement_3}, {RSTD measurement_4, PRS resource measurement_4}, {RSTD measurement_5, PRS resource measurement_5}, {RSTD measurement_6, PRS resource measurement_6}, {RSTD measurement_7, PRS resource measurement_7}, {RSTD measurement_8, PRS resource measurement_8}. Upon receiving the eight sets of measurements, the LMF 314 may be configured to classify the eight sets of measurements into two groups (group 1 and group 2) based on the eight RSTD measurements (RSTD measurement_1 to RSTD measurement_8) from the eight sets of measurements using a procedure similar to Algorithm 1. In some examples, group 1 and group 2 comprise four sets of measurements, respectively. Then the LMF 314 may be configured to further classify the four sets of measurements in group 1 into two subgroups (subgroup 1 and subgroup 2) based on the four PRS resource measurements from the four sets of measurements in group 1, and classify the four sets of measurements in group 2 into three subgroups (subgroup 3, subgroup 4 and subgroup 5) based on the four PRS resource measurements from the four sets of measurements in group 2. Since the RSTD measurements and PRS resource measurements in the same subgroup share similar measurement values, one single error distribution for each type of measurements in each of the subgroups 1-5 can be estimated for positioning integrity analysis. In some embodiments, each error distribution for each type of measurements corresponding to subgroups 1-5 comprises a normal distribution with a respective mean and a respective standard deviation. In this way, positioning integrity analysis can be performed in a more accurate manner.

In some embodiments, a subgroup x may comprise n sets of measurements, wherein each of the n sets of measurements comprises p measurements: {measurement 1 . . . , measurement p}. The p measurements may comprise a measurement that has not been used for classifying the subgroup x. For example, p measurements may comprise a LOS-NLOS indicator that has not been used for classifying the subgroup .x. Consequently, the n LOS-NLOS indicator values in the n sets of measurements may comprise both zero LOS-NLOS indicator values for LOS and one LOS-NLOS indicator values for NLOS. In such a case, the error distribution estimation for subgroup x may not be accurate due to existence of different LOS-NLOS indicator values. To solve this problem, different scale factors (e.g. scale factor K in Equation 3) can be assigned to measurements associated with a zero LOS-NLOS indicator value and a one LOS-NLOS indicator value, respectively, to weight the influence of different LOS-NLOS indicator values on the estimated error distributions. For example, error distribution estimated from measurements associated with a zero LOS-NLOS indicator value can be assigned a scale factor of 0.7, while error distribution estimated from measurements associated with a one LOS-NLOS indicator value can be assigned a scale factor of 0.3.

Although classifying UE measurements into different groups is performed by the LMF 314 as illustrated in previous exemplary embodiments, it is understood that classifying UE measurements can also be performed by other communication devices or nodes, for example by the UE 304 or the BS 302.

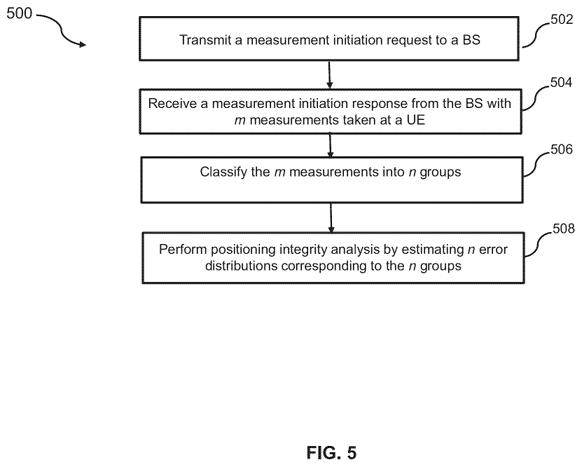

FIG. 5 illustrates an example method 500 performed by a network node (e.g. an LMF) for classifying m measurements taken at a UE into n groups, in accordance with some embodiments. The operations of method 500 presented below are intended to be illustrative. In some embodiments, method 500 may be accomplished with one or more additional operations not described and/or without one or more of the operations discussed. Additionally, the order in which the operations of method 500 are illustrated in FIG. 5 and described below is not intended to be limiting.

At operation 502, the LMF may transmit a measurement initiation request to a BS. The measurement initiation request may be an E-CID measurement initiation request message, an E-UTRA RSRP measurement initiation request message, an E-UTRA RSRQ measurement initiation request message, or an OTDOA measurement initiation request message. In some embodiments, the measurement initiation request includes indication of whether the measurement result from the UE is expected only once or periodically. In some embodiments, upon receiving the measurement initiation request, the BS may transmit the measurement initiation request to the UE and receive measurements taken at the UE through an RRC measurement procedure. In other embodiments, the LMF may transmit the measurement initiation request directly to the UE without participation of the BS.

At operation 504, the LMF may receive a measurement initiation response from the BS. In some embodiments, the measurement initiation response comprises m measurements performed at the UE. The m measurements performed at the UE may include one of: TRP location measurements, PRS resource set measurements, LOS-NLOS indicators, RSRP/RSRPP measurements, Rx-TEG measurements, path indicators, periodic indicators, RSTD measurements, Rx beam index measurements, RTOA measurements, AoA measurements, AoD measurements, UE Rx-Tx timing difference measurements, BS Rx-Tx timing difference measurements, inter-TRP synchronization measurements. In other embodiments, the LMF may receive the measurement initiation response directly from the UE without participation of the BS.

At operation 506, the LMF may classify the m measurements into n groups of measurements, m≥n. In some embodiments, a predetermined threshold value is used to classify the m measurements into n groups of measurements. In some embodiments, the m measurements are classified into n groups of measurements using a k-means clustering algorithm combined with the predetermined threshold value.

At operation 508, the LMF may perform positioning integrity analysis by estimating n error distributions for the n groups of measurements, respectively. In some embodiments, each of the n error distributions is one of a normal distribution, a uniform distribution, a log-normal distribution, a multimodal distribution, a binomial distribution, a Poisson distribution, and a non-parametric distribution. In other embodiments, the LMF is configured to convert at least one of the n error distributions to a normal distribution if the at least one of the n error distributions is a non-normal distribution.

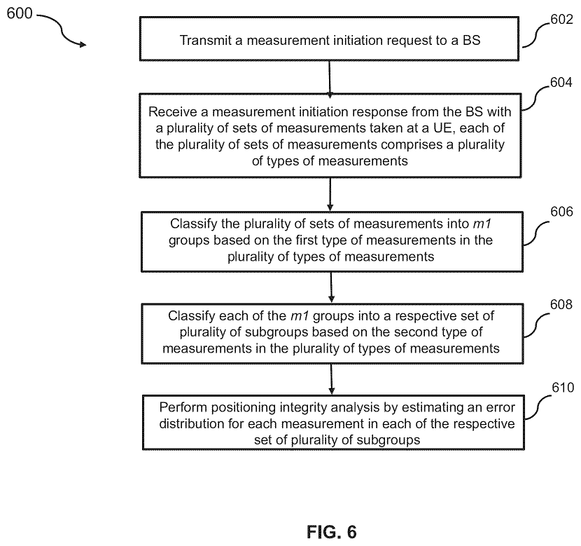

FIG. 6 illustrates another example method 600 performed by a network node (e.g. an LMF) for classifying a plurality of sets of UE measurements for positioning integrity analysis, in accordance with some embodiments. The operations of method 600 presented below are intended to be illustrative. In some embodiments, method 600 may be accomplished with one or more additional operations not described and/or without one or more of the operations discussed. Additionally, the order in which the operations of method 600 are illustrated in FIG. 5 and described below is not intended to be limiting.

At operation 602, the LMF may transmit a measurement initiation request to a BS. In some embodiments, upon receiving the measurement initiation request, the BS may configure a UE to report measurement information through an RRC measurement procedure. In other embodiments, the LMF may transmit the measurement initiation request directly to the UE without participation of the BS.

At operation 604, the LMF may receive a measurement initiation response from the BS. In some embodiments, the measurement initiation response comprises a plurality of sets of measurements taken at the UE, wherein each of the plurality of sets of measurements comprises a plurality of types of measurements. In some embodiments, the plurality of types of measurements comprises at least two of: RSTD measurements, TRP location measurements, PRS resource measurements, LOS-NLOS indicators, RSRP/RSRPP measurements, Rx TEG measurements, path indicators, periodic indicators, Rx beam index measurements, RTOA measurements, AoA measurements, AoD measurements, UE Rx-Tx timing difference measurements, BS Rx-Tx timing difference measurements, inter-TRP synchronization measurements. In other embodiments, the LMF may receive the measurement initiation response directly from the UE without participation of the BS.

At operation 606, the LMF may classify the plurality of sets of measurements into m1 groups based on the first type of measurements in the plurality of types of measurements. In some embodiments, a predetermined threshold value is used to classify the plurality of sets of measurements into m1 groups. In some embodiments, the plurality of sets of measurements are classified into m1 groups using a k-means clustering algorithm combined with the predetermined threshold value. In some embodiments, one error distribution for each type of measurements in each of the m1 groups can be estimated for positioning integrity analysis.

At operation 608, the LMF may classify each of the m1 groups into a respective set of plurality of subgroups based on the second type of measurements in the plurality of types of measurements. In one example, the LMF is configured to classify the first group of the m1 groups into m2 subgroups based on the second type of measurements in the plurality of types of measurements, and to classify the second group of the m1 groups into m3 subgroups based on the second type of measurements in the plurality of types of measurements, and so on.

At operation 610, the LMF may perform positioning integrity analysis by estimating an error distribution for each measurement in each of the respective set of plurality of subgroups. In some embodiments, each error distribution for each measurement in each of the respective set of plurality of subgroups is one of a normal distribution, a uniform distribution, a log-normal distribution, a multimodal distribution, a binomial distribution, a Poisson distribution, and a non-parametric distribution.

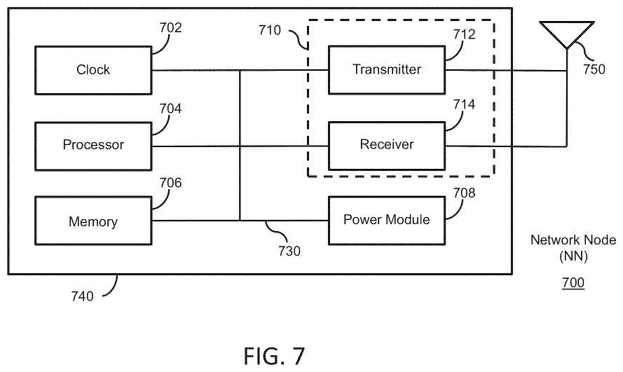

FIG. 7 illustrates a block diagram of a network node (NN) 700, in accordance with various embodiments of the disclosure. The NN 700 is an example of a wireless communication device or wireless communication node that can be configured to implement the various methods described herein. In some embodiments, the NN 700 may be a network entity such as an LMF, as described herein. In other embodiments, the NN 700 may be a wireless communication node such as a BS, as described herein. In yet other embodiments, the NN 700 may be a wireless communication device such as a UE as described herein. As shown in FIG. 7, the NN 700 includes a housing 740 containing a system clock 702, a processor 704, a memory 706, a transceiver 710 comprising a transmitter 712 and receiver 714, and a power module 708.

In this embodiment, the system clock 702 provides the timing signals to the processor 704 for controlling the timing of all operations of the NN 700. The processor 704 controls the general operation of the NN 700 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data. In some embodiments, when the NN 700 is an LMF, the processor is configured to perform one or more of the functions of the LMF described above. In other embodiments, when the NN 700 is a BS, the processor is configured to perform one or more of the functions of the BS described above. In alternative embodiments, when the NN 700 is a UE, the processor is configured to perform one or more of the functions of the UE described above.

The memory 706, which can include both read-only memory (ROM) and random access memory (RAM), can provide instructions and data to the processor 704. A portion of the memory 706 can also include non-volatile random access memory (NVRAM). The processor 704 typically performs logical and arithmetic operations based on program instructions stored within the memory 706. The instructions (a.k.a., software) stored in the memory 706 can be executed by the processor 704 to perform the methods described herein. The processor 704 and memory 706 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 710, which includes the transmitter 712 and receiver 714, allows the NN 700 to transmit and receive data to and from an external network node (e.g., an UE or BS). An antenna 750 is typically attached to the housing 740 and electrically coupled to the transceiver 710. In various embodiments, the NN 700 includes (not shown) multiple transmitters, multiple receivers, and multiple transceivers. In some embodiments, the antenna 750 includes a multi-antenna array that can form a plurality of beams each of which points in a distinct direction in accordance with MIMO beamforming techniques.

The various components and modules discussed above within housing 740 are coupled together by a bus system 730. The bus system 730 can include a data bus and, for example, a power bus, a control signal bus, and/or a status signal bus in addition to the data bus. It is understood that the modules of the NN 700 can be operatively coupled to one another using any suitable techniques and mediums. It is further understood that additional modules (not shown) may be included in the NN 700 without departing from the scope of the disclosure.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method performed by a wireless communication node, the method comprising:
receiving, from a wireless communication device, an assistance data request for assistance data, wherein the assistance data is related to an error source;
transmitting the assistance data to the wireless communication device; and
performing a positioning integrity analysis based on the assistance data.

2. The method of claim 1, further comprising:
transmitting a measurement initiation request related to a carrier phase configured to be received by the wireless communication device; and
receiving a measurement initiation response related to a carrier phase, wherein the measurement initiation response comprises a plurality of measurements performed by the wireless communication device.

3. The method of claim 2, further comprising:
transmitting a measurement request for at least one of a carrier phase related measurement or a measurement quality parameter; and
receiving a measurement result report based on the measurement request,
wherein the measurement result report comprises the at least one of a carrier phase related measurement or a measurement quality parameter.

4. The method of claim 1, wherein performing a positioning integrity analysis based on the assistance data comprises:
performing the positioning integrity analysis by obtaining an error distribution related parameter of the assistance data.

5. The method of claim 2, wherein the assistance data and/or the plurality of measurements correspond to at least one of the following error sources: ARP location, TRP location, Inter-TRP synchronization, boresight direction of DL-PRS related error, beam information of DL-PRS related error.

6. A method performed by a wireless communication device, comprising:
transmitting an assistance data request for assistance data configured to be received by a wireless communication node; and
receiving the assistance data, wherein the assistance data is related to an error source,
wherein the wireless communication node is configured to perform a positioning integrity analysis based on the assistance data.

7. The method of claim 6, further comprising:
receiving a measurement initiation request related to a carrier phase; and
transmitting a measurement initiation response related to a carrier phase configured to be received by the wireless communication node, wherein the measurement initiation response comprises a plurality of measurements performed by the wireless communication device.

8. The method of claim 7, further comprising:
receiving a measurement request for at least one of a carrier phase related measurement or a measurement quality parameter; and
transmitting a measurement result report based on the measurement request,
wherein the measurement result report comprises the at least one of a carrier phase related measurement or a measurement quality parameter.

9. The method of claim 6, wherein the wireless communication node is configured to perform the positioning integrity analysis based on the assistance data by:
performing the positioning integrity analysis by obtaining an error distribution related parameter of the assistance data.

10. The method of claim 7, wherein the assistance data and/or the plurality of measurements correspond to at least one of the following error sources: ARP location, TRP location, Inter-TRP synchronization, boresight direction of DL-PRS related error, beam information of DL-PRS related error.

11. A wireless communication node comprising:
a transceiver configured to:
receive, from a wireless communication device, an assistance data request for assistance data, wherein the assistance data is related to an error source; and
transmit the assistance data to the wireless communication device, at least one processor configured to:
perform a positioning integrity analysis based on the assistance data.

12. The wireless communication node of claim 11, the transceiver is further configured to:
transmit a measurement initiation request related to a carrier phase configured to be received by the wireless communication device, and
receive a measurement initiation response related to a carrier phase, wherein the measurement initiation response comprises a plurality of measurements performed by the wireless communication device.

13. The wireless communication node of claim 12, the transceiver is further configured to:
transmit a measurement request for at least one of a carrier phase related measurement or a measurement quality parameter; and
receive a measurement result report based on the measurement request,
wherein the measurement result report comprises the at least one of a carrier phase related measurement or a measurement quality parameter.

14. The wireless communication node of claim 11, wherein the at least one processor is configured to perform a positioning integrity analysis based on the assistance data by:
performing the positioning integrity analysis by obtaining an error distribution related parameter of the assistance data.

15. The wireless communication node of claim 12, wherein the assistance data and/or the plurality of measurements correspond to at least one of the following error sources: ARP location, TRP location, Inter-TRP synchronization, boresight direction of DL-PRS related error, beam information of DL-PRS related error.

16. A wireless communication device comprising:
a transceiver configured to:
transmit an assistance data request for the assistance data configured to be received by a wireless communication node,
receive the assistance data, wherein the assistance data is related to an error source;
wherein the wireless communication node is configured to perform a positioning integrity analysis based on the assistance data.

17. The wireless communication device of claim 16, the transceiver is further configured to:
receive a measurement initiation request related to a carrier phase; and
transmit a measurement initiation response related to a carrier phase configured to be received by a wireless communication node, wherein the measurement initiation response comprises a plurality of measurements performed by the wireless communication device.

18. The wireless communication device of claim 16, the transceiver is further configured to:
receive a measurement request for at least one of a carrier phase related measurement or a measurement quality parameter; and
transmit a measurement result report based on the measurement request,
wherein the measurement result report comprises the at least one of a carrier phase related measurement or a measurement quality parameter.

19. The wireless communication device of claim 16, wherein the wireless communication node is configured to perform the positioning integrity analysis based on the assistance data by:
performing the positioning integrity analysis by obtaining an error distribution related parameter of the assistance data.

20. The wireless communication device of claim 17, wherein the assistance data and/or the plurality of measurements correspond to at least one of the following error sources: ARP location, TRP location, Inter-TRP synchronization, boresight direction of DL-PRS related error, beam information of DL-PRS related error.
